(19) United States
(12) Patent Application Publication
(10) Pub. No.: US 2003/0197736 A1
(43) Pub. Date: Oct. 23, 2003

(54) User interface for character entry using a minimum number of selection keys

(76) Inventor: Michael W. Murphy, Manchester, NY (US)

Correspondence Address: BASCH & NICKERSON LLP, 1777 PENFIELD ROAD, PENFIELD, NY, 14526, US

(21) Appl. No.: 10/448,912

(22) Filed: May 30, 2003

Related U.S. Application Data
(63) Continuation-in-part of application No. 10/050,201, filed on Jan. 16, 2002.

(51) Int. Cl. G09G 5/00

(52) U.S. Cl. 345/780; 345/827

(57) ABSTRACT

The present invention is a method and apparatus for entry of alphanumeric characters or symbols, employing fewer, data entry keys than the number of characters to be selected from. In particular the invention “multiplexes” a given display area to control the display of specific character groupings and to facilitate user selection and entry or editing of characters.

### CROSS REFERENCE

Priority is claimed from the following related, co-pending application, which is also hereby incorporated by reference for its teachings:

“USER INTERFACE FOR CHARACTER ENTRY USING A MINIMUM NUMBER OF SELECTION KEYS,” Michael W. Murphy, application Ser. No. 10/050,201, filed Jan. 16, 2002, and published on Jul. 18, 2002 (US 2002/0093535A1).

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY OF THE INVENTION

Manual alphanumeric or symbolic data entry is commonly accomplished employing an array of keys representing characters comprising alphanumeric characters, a spacebar, and symbols that are manually activated by the user in selecting text, or otherwise entering data. In personal computers and workstations, such selections are translated by word processing or spreadsheet applications, for example, and displayed or printed as the text is composed or data is entered. The keys of a keyboard are typically depressed in a time sequence to formulate words from individual alphabet characters or to enter numeric values. An application can provide for special cases requiring simultaneous depression of two or more keys to format text or for other control features, i.e. a Shift key. However, in general the keyboard keys and associated characters are visually and tactually distinguished only by their physical, fixed position in the keyboard array.

Current Roman alphabet computer keyboards retain key size, spacing and alphanumeric character layout of earlier mechanical and electrical typewriters in large part to accommodate persons trained in usage of the QWERTY keyboards to perform long taught typing methods at speeds on the order of 75 words per minute. As new keys have been required, this traditional keyboard has been further enhanced using special keys like “Ctrl” and “Alt” whereby a different ASCII character from ‘x’ is perceived by the computer when ‘Ctrl’ and ‘x’ are pressed at the same time. Furthermore, full point-and-click menu systems have been invented for other special characters. Generally, speed and accuracy of typing using traditional methods decrease as key size and spacing are compressed. Thus, personal computer keyboards are relatively large and in many cases exceed the size of earlier typewriter keyboards typically due to added special purpose keys or splitting apart of keys depressed by the right and left hand fingers..

As technology has improved, miniaturized portable computers, cellular phones, instant messaging devices, pagers, personal digital assistants (PDAs), digital watches, calculators and other special purpose personal equipment have proliferated for performing traditional computing functions and for communicating over wired and wireless networks. One consequence of these advances is that such miniaturized portable devices have grown considerably smaller than the personal computer keyboards used to input data into them. Accordingly, alternative data entry systems have been devised to enable alphanumeric and data entry into these miniature devices.

In one approach, data entry is accomplished using highly miniaturized limited function keyboards having mechanical keys in a physical keyboard array or keys graphically displayed on a touch-screen associated with the device, and the user is required to compose text and enter data using a pointer to select a character. In other approaches, a limited number of hard or soft keys are provided, and shorthand messages can be composed by an encrypted means. Although these keyboards do enable text and data entry on these miniaturized devices, it is often tedious and impractical, either due to the physically small size of the keys compared to the user's fingers, or the inconvenience of having to use a pointer to press the keys.

The spatial limitations inhibiting usage of the traditional keyboard in such miniaturized equipment have prompted a number of other proposals to increase speed and accuracy of data entry, text composition, and the like, using a lesser number of keys. See for example, U.S. Pat. Nos. 4,737,980, 5,543,818, 5,790,115, 5,812,117, 5,982,351, 6,011,542, 6,021,312, 6,031,471, and 6,104,317, the teachings of which are hereby incorporated by reference in their entirety. In these approaches, the physical equipment is hardware and/or software modified to enable character selection by the user of displayed characters of full collection of characters or partial collection of characters employing a fewer number of keys than characters in the collection of characters.

Some of these approaches deal with the use of the available key set of the particular device, e.g., the 3×4 key standard telephone key pad (the '980 and '317 patents), video game controllers (the '818 patent), pagers (the '312 patent), television channel remote controllers (the '115 patent), and others. Some of these use a cursor moved by mouse or up-down and left-right cursor movement keys to scroll through displayed characters (the '117, '471, '351, '541 and '542 patents) or to scroll characters through a character position of a word (the '115 patent) to select the proper character when it is in the select position using a keystroke or mouse click or a stylus applied against the touch sensitive screen.

In one operating mode of the '542 patent, a circular character wheel is displayed on a graphical text entry screen or display, the user rotates the character wheel until a desired character in a particular collection of characters, e.g., the 26 letter alphabet, is in a selection window using a key of the device. The user selects the character using another key or keystroke, and the selected character is displayed in a text entry screen. Scrolling about the entire alphabet is slow and occupies a large part of the display. In another operating mode, only a portion of the full alphabet is depicted on a smaller portion of the display. The user then advances the character wheel to display the desired letter, and it is selected in the same fashion. Only one collection of characters is displayed and scrolled through at any time, and the user has to successively display other collections of characters, e.g. numerals, symbols or punctuation marks until a desired set is displayed. A similar approach is described in the '117 patent. Again, this operating mode is inherently slow and not user friendly.

In the '115 patent, the letters of the alphabet and a space in a character spin dial are scrolled by the user manipulating up-down keys to successively display characters in each character position or cell of characters that make up a word that is entered in a text display region of the display. Presumably other characters and punctuation marks and the like can be selected and scrolled through. Again, the process is slow and suited to very limited text entry.

Thus, up to now, user specification of a desired character from a collection of characters has been shown to be accomplishable in one of two fundamental ways. In the first way, there are as many selection keys as there are unique characters. When the user presses a selection key, the character identified with that key is entered. In the second way, there is a display window and a single selection key. When the user presses the selection key, the character being displayed in the display window at the time that the selection key is pressed, is entered.

From this, it can be concluded that there are two variables that can be used to specify a character. In the first method, it is position. In the second method, it is time. Up to now, these methods have been used independently, and using position to distinguish characters has been, by far, the most popular, as exemplified by the popularity of the QWERTY keyboard. However, for miniature devices there remains an unmet need for improvements in data entry that is sufficiently compact to fit onto the face of the device while at the same time not severely compromising the speed, accuracy, and user convenience of inputting data to the device.

In the invention described here, the two separate methods of specifying a character (position and time) are recognized, and then used together to form a multiplexed method of specifying a character.

In the character specification methods described above, all the characters either had their own selection key, or their own selection time in the display window. In this new method and associated apparatus, few or no characters have their own selection key, and no character ever has its own display time. In this method, both the selection key pressed and the time that it is pressed determine the character desired for specification.

To accomplish this, a special organization of the characters in the alphabet is made. The optimum organization requires knowledge of the number of unique characters in the overall collection of characters (x), the number of selection keys desired (z), and the number of character groups that is convenient and acceptable (y).

In this organization, the entire collection of characters is first divided up into character groups. A character group is a subset of characters from the total collection of characters. The collection of characters is divided up so that every character falls into a group, and so that there are approximately the same number of characters in each group.

To take advantage of this organization, a keyboard having both a display window and selection keys is used. Optimally, the display window holds as many characters as there are in a single character group, and there are at least as many selection keys as the display window holds characters. As stated above, both the selection key pressed, and the time that it is pressed, will be used to determine the character desired for specification.

To do this, characters are presented to the user in the display window in groups. To specify a character from the displayed group, the selection key associated with that character's position in the display window is pressed. If the character desired for selection is not displayed, the character group is changed to the group containing the desired character. Then, at the time that the character group containing the desired character is displayed, the desired character is specified by pressing the selection key associated with that character's position in the display window. Repeating this in time sequence, characters can be selected to build the text or data string desired for entry.

It will be appreciated that the invention is implemented in software routines or applications that may allow for customization by the user to define the number of display windows or corresponding character groups, the characters in each character group, the hardware or displayed keys to be employed in selecting characters in the display window, as well as user definable keys. The user can then load the software and the custom settings into any compatible device, whereby the user enjoys the benefits of a personalized and portable keyboard. In order to facilitate such portability from device to device, keyboard configurations could be downloadable to any compatible system to facilitate character entry. This would permit users who have become accustomed to their own keyboard on their portable devices or desktop computer to use that same keyboard on other devices that they use. Such users could physically or virtually carry an electronic copy of “their” keyboard with them, for example, as part of a user's profile associated with a device. Their “virtual” keyboard could be downloaded through an Internet or intranet connection into whatever device that they want to use.

The usefulness of the invention described herein is that it offers a method for entering data into a portable or miniature electronic device, one too compact for a conventional keyboard, without severely compromising data entry speed, accuracy, and convenience.

In accordance with the present invention, there is provided a method of character data entry through a user's sequential selection of characters, from a collection of characters, depicted on a display, comprising: defining a plurality of character groups from the collection of characters, wherein the number of character groups is less than the number of characters in the collection of characters; providing a display window within a screen to display at least one of said character groups in the display window; displaying the characters of one of the plurality of character groups in the display window; providing means to change the character group displayed in the display window from one group to another; detecting the selection by the user of one of the characters displayed in the display window; and entering the user selected character.

In accordance with another aspect of the present invention, there is provided a method of character entry through a user's sequential selection of characters, from a collection of characters, depicted on a display, comprising: a. dividing the characters of a collection of characters into a plurality of smaller, like-sized groups; b. providing at least one display window on a display screen; c. providing an action key for user selection of at least one of the plurality of smaller, like-sized groups of characters; d. selecting the action key to specify one of the plurality of smaller, like-sized groups of characters for display; e. displaying at least one of the characters in a specified character group in the display window; f. providing at least one selection button for at least one of the characters displayed; g. selecting a character from the characters displayed; and h. entering the selected character as input..

In accordance with yet another aspect of the present invention, there is provided a user operable character selection and entry system for compiling characters into a text string of characters by selection from a displayed character group comprising: at least one character group graphic display window within the screen; a selected character entry means wherein the character group display window is directly associated with a physical character entry key; means responsive to detecting the user activation of a physical key; means for detecting the user selection of a character group; and means responsive to detecting the user selected character group.

In accordance with a further aspect of the present invention, there is provided a user operable system for the multiplexed selection of characters, from a collection of characters, depicted on a display, comprising: at least one character group depicted in a spatial dimension on a display window of the system; navigation means for alternately displaying, in a time dimension, one of a plurality of character groups selected from the collection of characters on the display window; and means for detecting a user selected character within a displayed character group in order to output a signal representing the selected character.

### BRIEF DESCRIPTION OF THE DRAWINGS

FIG. 1 is a representative illustration of an embodiment of the present invention displayed in accordance with a personal digital assistance device;

FIG. 2 is an illustrative example of one manner of dividing a collection of characters into a plurality of character groups for display in accordance with the present invention;

FIGS. 3A-3F display specific implementations of the character selection tool embodiment in accordance with the respective character groups of FIG. 2;

FIG. 4 is an alternative embodiment of the present invention enabling the selection of multiple characters with a single user operation;

FIGS. 5A and 5B are flowcharts depicting a methodology for implementing the present invention;

FIGS. 6 and 7 depict, respectively, the front and rear views of the personal digital assistance device of FIG. 1 in accordance with another aspect of the present invention;

FIGS. 8 and 9 depict, respectively, the front and rear views of a personal communication device in accordance with another aspect of the present invention; and

FIG. 10 depicts a cellular telephone employing software in accordance with the present invention to enable the rapid entry of textual information using a conventional telephone keypad.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

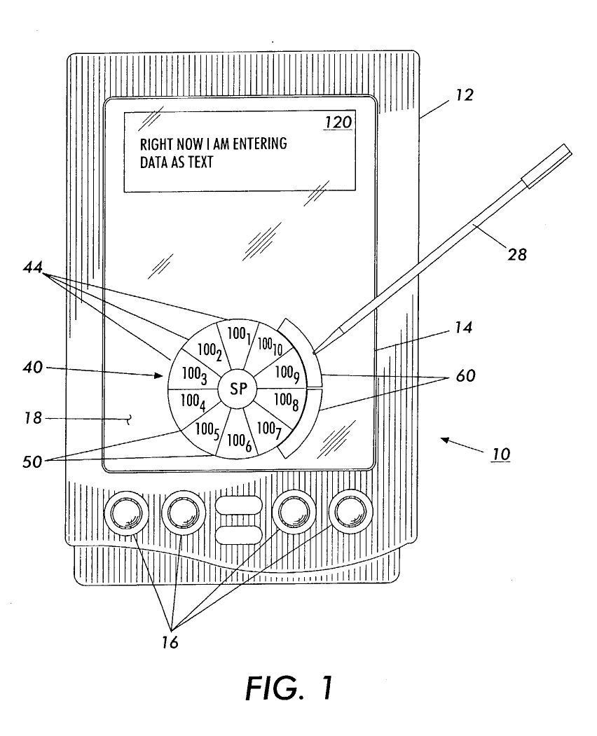

For a general understanding of the present invention, reference is made to the drawings. In the drawings, like reference numerals have been used throughout to designate identical elements. The present invention is intended to be implemented in any device enabling or requiring data entry wherein a user selects characters to formulate text or mathematical expressions or the like to convey information, formulate operating code, make a telecommunication connection or for any other reason. Thus, data entry devices comprise personal desktop and portable computers, personal digital assistants, portable web access devices, telecommunications devices, digital watches, calculators and the like. For convenience, the preferred embodiments of the present invention are described herein in the context of entering text into a personal digital assistant (PDA) as generally illustrated in FIG. 1.

As used herein, the term collection of characters is intended to represent various categories (e.g. alphabetical characters, numerical characters, punctuation, QWERTY keyboard characters (upper and/or lower case), symbols (e.g., wingdings), functions, etc.), or combinations thereof that may be selected or desired for selection by a user inputting character data. While the term category is intended to represent a set of related characters, collection is intended to represent the possibility of one or more categories of characters or subsets of one or more categories, etc.

In FIG. 1, the PDA 10 (illustrated in U.S. Design Pat. No. D397,679) comprises a case 12 enclosing the battery and micro-computer based operating system, and supporting an electronic display 14 (e.g., LCD), located under a touch sensitive screen 18, keys 16 are physical buttons, some of which are soft keys and thereby user defined, and port (not shown) along the sides of case 12 for making connections with other devices using infrared (IR), radio frequency (RF), or direct connection. Operating programs for word processing and spreadsheet applications can be loaded into memory of the PDA operating system for use by the user. A stylus or pen 28 is slipped into a holder (not shown) along a side of the PDA case 12 and may also be employed by the user to enter data or initiate program specific functions by pressing the stylus upon the touch screen 18 where icons or characters are displayed on the screen 14. This coordinate selection method, as well as the supporting operating system and keys, is an entry process well known in the art.

FIG. 1 depicts a first embodiment of an apparatus and method of character data entry of the present invention. The apparatus of the present invention is realized when software code suitable for implementing the functionality of the present invention is loaded as a program into the operating system of the PDA 10 or other device of the types listed above. Thus, a user of any such programmable device as PDA 10 would load the program into the device memory or purchase the device having the program already installed and develop a personalized and portable keyboard as summarized above and described further herein.

The electronic display 14 depicts one of a possible plurality of character group graphic windows 40 containing a plurality of character selection segments 44 organized in a non-rectangular form. More specifically, the character selection segments 100₁, 100₂, . . . 100₁₀ are depicted on the display in a circular format, with a center, circular region “SP” allocated for the “space” character. FIG. 1 also is intended to illustrate that touch screen 18 overlays the graphic window 40, thereby having touch coordinates which directly coincide with the respective displayed character segment position within the graphic window. In response to such a selection, the stylus location (or hard button selection) is detected by the PDA controller, thereby providing means for detecting the user selected character or display feature within the window 40.

In order to enable the selection of more unique characters than there are character selection segments, the characters that the collection of segments represent can be changed. This can be accomplished using action keys 16, or other hard or soft keys. As used herein, hard keys are intended to represent physical keys or buttons wherein the action is controlled by an associated switch or equivalent electromechanical device. Soft keys are intended to be programmable elements that may be associated with a touch-sensitive display of similar component, where the size and/or location are adjustable. It is entirely possible that a soft key is transparent to a user and is simply sensitive to a user's touch or a stylus at an underlying display item. For each group of characters that can be inserted into the segments of character group display window 40, there is either a unique key , or unique key action, that allows the user to direct the device as to the character group that is desired for display. The user would typically learn over time which character groups are associated with which keys and key actions, however a legend could also be included on the device in order to help the user to remember.

The benefit of being able to change as a group what the collection of display segments and selection segments represent is that the user is able to quickly access a larger number of unique characters than there are unique selection segments on the device.

In the case of a round character display window, one special segment is the center segment. This special segment is a universal segment for which the character it represents does not change when the displayed character group is changed. A space is entered by selecting or pressing the center segment, designated by the letters “SP”, regardless of the character group being displayed. Furthermore, the “SP” or space button may also function as a “Return” key, where a carriage return is entered by double-clicking or rapidly double-selecting this or a similarly designated position. There may also be other universal segments, similar to the space button, that do not change when the displayed character group changes. An embodiment of this would be achieved by dividing the circular space button into halves, thirds, quarters, or more, and assigning characters to these segments.

Although other alternatively-shaped segments are contemplated, the pie-shaped selection and display segments or “keys” 44 of FIG. 1 will be used to describe the operation of one embodiment of the present invention.

An additional aspect of this embodiment is that the size of the space segment, and/or the size of the display window, may be altered by a user. More specifically, it is contemplated that the center circle for the “SP” segment may be resized by the user pressing on an edge of the segment with a stylus tip and dragging inward toward the center to make the segment smaller, or outward from the center to make the segment larger. Similarly, pressing and dragging on the outer edge of the circular display region, possibly at one or more designated control points 50 at the junction of the segments, will cause the entire circular display window to be resized. When the display is re-sized, the pie-shaped segments 100₁, 100₂, . . . 100₁₀ and SP segment expand or contract proportionally. However, when the space button is re-sized, the space button may expand or contract at the gain or expense of the surrounding segments. A further variation is one in which different character groups have a different number of segments, and where all the segments are not necessarily the same size. In this variation, the number of segments, or the size of each segment, can be varied by the user by dragging segment borders or boundaries closer or further apart, or by closing a segment entirely in order to remove that segment. Lastly, in addition to being resizable and where the shape may be adjusted by movement of boundaries, the display window(s) itself can also be repositioned on the display using a similar, well known select and drag technique.

This provides a user-friendly interface whereby you simply point to or touch the character to facilitate its selection and entry into the application. As will be appreciated from known PDA devices, the manual tapping, or scrolling of a selection cursor (not shown) to the desired display location (mapped to the desired character or symbol in this embodiment) results in the selection of the character or symbol for entry.

The program detects when the user has made a selection of a character within the group of characters displayed in a display window 40 and that character is entered into the data stream and shown within a character string in the text transcript window 120. In this particular application, the data stream comprises letters of text, and those letters and at least the most recent portion of the text are displayed in window 120 within the display 14. In this way, a user may validate the selected characters and if need be re-select and edit characters as they are displayed in the display window 120. Once verified the text can be saved, transmitted and/or printed. The display window 40 depicts, in accordance with the present invention, at least one character group shown in a spatial dimension in order to provide a user operable system for the multiplexed selection of characters.

FIG. 1 shows, for example, the formation of the text string, “. . . IGHT NOW I AM ENTERING DATA AS TEXT” where the letter have been selected by tapping the segment, or “button” 44, immediately over the desired character's illustration within the character group graphic window 40. In the process of being entered the selected character will also appear in the text window 120. Upon selection an audible tone may be generated by the device and the desired character graphic may be “highlighted” showing this selection, and, in practice, it may well be desirable to color highlight the selection as a visual aid to the user.

In establishing this text entry method, it must be decided what characters from the collection of characters will appear together in a single display group. In other words, what criteria will be used to decide what characters are grouped with what other characters?

It is of primary importance when dividing the characters of an alphabet or other related set of characters into character groups to consider associations between the characters. Intuitive division of the characters enables the user to take advantage of familiar relationships between characters to help the user find a desired character based on some fundamental and established policies. An example of this technique is to take advantage of the user's familiarity with the conventional order of the letters of the Roman alphabet. By placing letters within character groups in the order they appear in the alphabet, and then by placing character groups in the order that the letters they hold appear in the alphabet, users can quickly locate a letter relative to the group that is displayed. In general, this search technique takes advantage of the fact that users recall the order of characters of the alphabet and know approximately in which portion of the alphabet a letter can be found. Users employing the Roman alphabet know that ‘d’ is near the beginning of the alphabet, and the letters ‘e’ and ‘f’ follow ‘d’. A user does not necessarily need to see the entire alphabet as long as they can ascertain that an “s” for example is in the third group, and can advance the displayed character group once or twice and the ‘s’ will appear in that character group display window. One limiting factor of this approach is that group selection could be required as a preface to selecting a majority of the keys. For example to type the word “dog” a character group would need to be identified before each character could be selected.

The general approach to group logistics is as follows; First define x as the total number of characters contained within the character collection, y as the total number of character groups, and z as the total number of characters per character group. Therefore the number of character groups (y), expressed as an integer, is equal to the total characters in the collection (x) divided by the desired characters within any group (z), and can simply be expressed as y=x/z. As can be seen from this equation, the multiplexing ratio is a function of the relationship between the values of x and z. For example if a compression to five character groups is optimum the ratio between x and z must be five or less.

In accordance with the invention, it is possible to provide a number of alternative modes of operation for the techniques of the present invention. Each of these will be described with reference to the remaining figures.

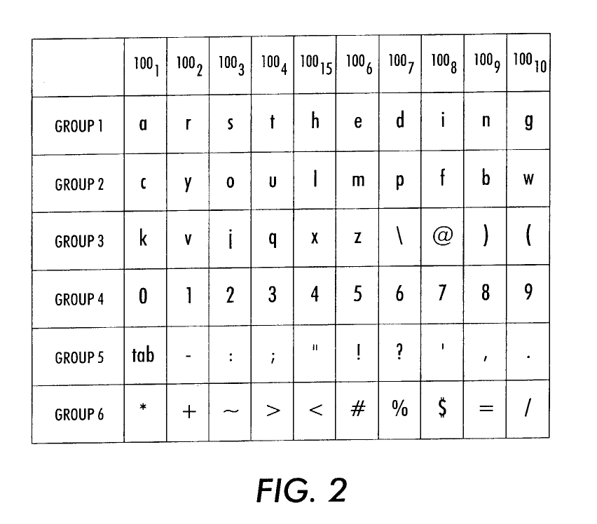

Turning to FIG. 2, shown therein is an exemplary embodiment of the character groupings employed for the present invention. This set of groupings (Groups 1-6), with each having ten display characters, overcomes the problem of having to frequently change the displayed character group by using character groups based on the probability of a specific character being selected. In the table, each row of characters is considered a single group. These 10 characters would appear together in the 10 segments of the display window if that character group's action key were selected. Each column shows the characters that can potentially appear on the character display window segment indicated at the top of the column. Thus, the letter “q” would be displayed when group 3 is shown in display window 40, and would be illustrated, and selected, via segment 100₄.

The benefit of segregating the characters so that the most frequently used characters appear together is that the user is able to type for long periods before having to change panels to access a less frequently used character. This saves time, and adds convenience.

Characters that are frequently used consecutively are also strategically positioned within a single group in order to further speed character selection. For example, t-h-e, e-d, and i-n-g on the default panel, and o-u, y-o-u, c-o-u-l, and w-o-u-l on the “up” panel. Further contemplated, although not shown, is the possibility that such subgroups may be selected by sweeping a stylus across the subgroup of character selection segments without raising it from the touch screen.

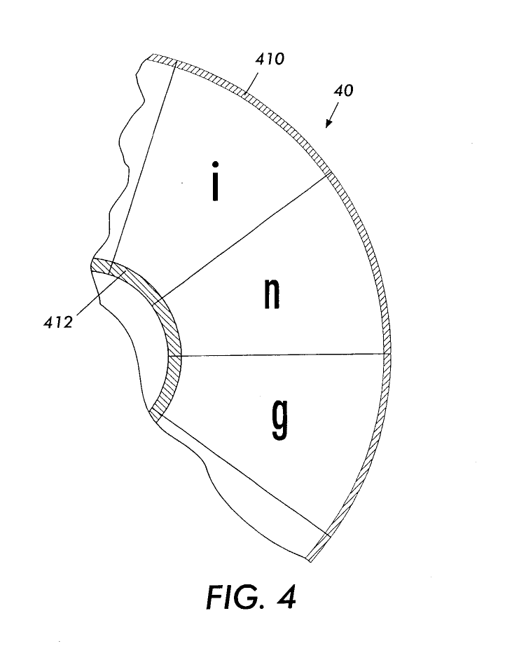

Referring briefly to the illustration of a partial display window 40 in FIG. 4, there is shown a series of three character representations for the letters “i”, “n” and “g”. Also shown are linking bars 410 and 412 that take up a portion of a character selection segment for each character in the subgroup, and that may be displayed and programmed to be sensitive to a stylus touching the touch screen in the regions represented by the bars. Touching the linking bar would result in a selection of the character group that the linking bar spans. It will be appreciated that equivalent alternatives to the linking bars, for example common control points, may also be employed to select the subgroups of characters.

It will be further appreciated that certain subgroups may also be represented on a single character selection segment for selection. Or, alternatively, the groups or selection segments displayed for a group may be employed to facilitate the selection of specific acronyms, abbreviations, measurement units (e.g., in., ft., mm, ° F.), commands, functions, etc. Furthermore, the present invention contemplates the use of alternative character groupings, and additional display windows for unique sets of character subgroups, abbreviations and acronyms. Although not shown here, on the actual board letters can be capitalized by pressing-and-holding on a character selection key (e.g., key 16 in FIG. 1), instead of making just a short “tap”.

There are at least two fundamental methods to establish character priority for assignment to a group that will be briefly described herein. In the first case character usage can be imputed by referencing a document containing the desired array of characters to be ranked. Based on the frequency of occurrence of a character in the text of the document, a list or table is constructed with the most populated character at the top. Subsequently this list is then segmented into the optimum number of groups where again y=x/z. Accordingly, in a more adaptive method, character grouping is established on a real time empirical basis whereby character usage is monitored on an ongoing basis and characters are assigned to a group on a dynamic ranking basis. In this manner the user actually teaches the application, over time and use, the character ranking priority and associated compiled group assignments.

Once the members of each character group have been established, a method is needed for the user to specify which group is desired for display in the character display window. This designation is accomplished using “action keys” and unique “key actions.” An “action key” is a hard or soft button associated with a particular character group. When a particular button is pressed, the character group associated with that button is displayed in the display window. In order to minimize the proliferation of action keys, “key actions” are used to further differentiate between various character groups. In this case, an action key can have more than one character group associated with it, and the particular character group desired by the user is by indicated by how the user presses the button.

Examples of action keys are button 16 or display feature 60 in FIG. 1. In this embodiment pressing button 16 could cause the display window to stop displaying the default character group, and replace it with another group of characters. Similarly, pressing feature 60 could cause the display window to display the character group containing punctuation characters.

Examples of key actions are a single-click as noted above, a press and hold, a double-click, or whatever action the user might specify on an “action key” to indicate the character set desired for display. In other words, it is believed preferable to enable the user to specify not only the button or segment that would trigger the selection of a character group, but also the type of action that results in the triggering the group selection.

Furthermore, there may be more than one action key for selection of a character group. Although it is possible to have a separate display feature 60 or button 16 to access each group, it is believed that it may be preferable to use multiple, unique selection actions on one or a few “keys” in order to minimize the number of action keys needed overall. In another embodiment, it is believed preferable to have, for every group requiring frequent access, a separate button or display feature. Groups not requiring frequent access can re-use a pre-existing action key, but are distinguished by a unique action on that key, for example, a double-click.

The action by which the user is returned from any panel to the default panel may also be established. For example, the user could be returned to the default panel by simply releasing a press-and-hold group selection key, by pressing the action key again, or by selecting a character from that panel. It is further contemplated that a timer may be used on the programmable controller (not shown) to automatically return to the last or the default character group after a period of time elapses since the last character selection.

As with accessing the group, the user action required to “leave” a group may be determined by the frequency of use of the characters in that group. For example, for groups requiring frequent access, a press and hold to access, and a simple release to leave, may be the most desirable as it appears to be the quickest and easiest way to switch between panels. However, for groups requiring infrequent, but sustained access, a single-click to access the group, followed by a single-click to leave may be desirable. The most obvious example of a character group that would use the latter is a group containing numbers. Numbers are used relatively infrequently in writing, but once needed, several digits are often needed in succession. Using a single-click selection action to both access and leave the number group the user can conveniently select a series of digits before leaving the panel. Finally, for groups requiring infrequent access, and for which sustained access is not needed, a single- or double-click to access, and the automatic return to default by the selection of a character from that group, may be most desirable. The most obvious application of this action methodology is a panel containing punctuation characters. This panel requires quick access, but once a character is selected, another character from this panel is normally not needed in succession.

As described above, the various key actions are clearly applicable, some to use of user-definable buttons 16 on the base or other regions of the PDA 10. However, it is entirely possible, that for some or all of the key actions leading to group selection, that certain of the actions may be facilitated by display elements such as elements 60 depicted in FIG. 1. Like the character selection segments 44 associated with characters, the display elements 60 may have associated regions on the touch screen 18 that are sensitive to tapping or touching with the tip of stylus 28.

As yet another “key action” it is contemplated that movement, or at least return to a previous character group displayed in the display window may be as a function of the time elapsed between the last user action. For example, a user makes a key action to “move” from displaying Group 1 to Group 4, but then does not make any character selection within Group 4 for greater than three seconds then the system would automatically return to the display of Group 1 characters in the window. Similarly, as noted above, the system may automatically return to the previous group of characters, or the default character group, Group 1, upon the selection of a character from the group of punctuation characters (e.g., Groups 5 and 6, or certain characters of Group 3). As described herein, the “key” actions and display features may be used separately or in combination to provide means for navigation in order to alternately display, in a time dimension, the plurality of character groups for user selection of characters therein.

Accordingly, the group selection “keys”, as described above, may take the form of a mechanical buttons 16 or a graphic element 60 on the display 14 as selected by the touch screen 18. Various actions may be used, preferably at the user's control, to cause the PDA to recognize a user's selection of a character group. Additionally there are various means to return to the default character group, including simply releasing the action key, selecting a character or by an interval timer.

In the case that no actions are taken on any of the action keys, then the default character group is displayed. Under normal circumstances, the character group containing the most frequently used characters would be picked as the default character group.

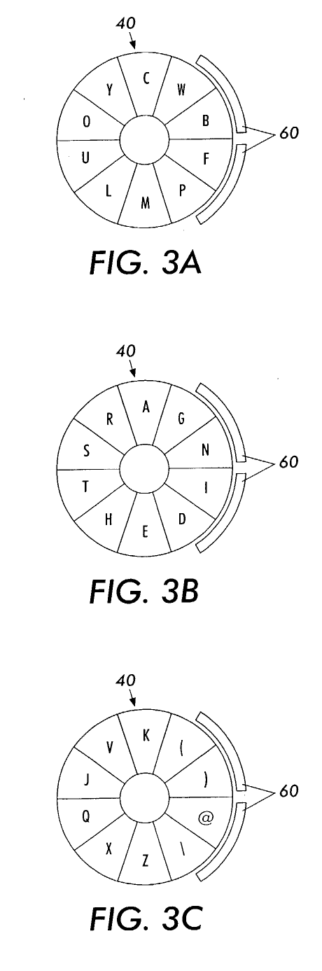

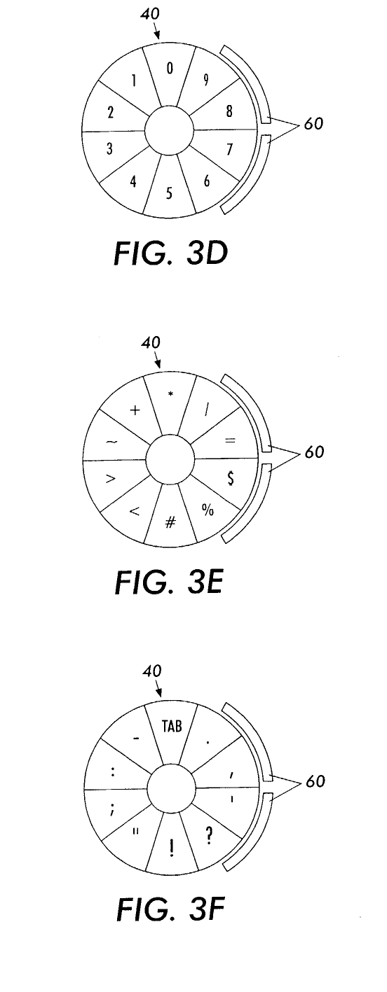

In FIGS. 3A-3F, the various character groupings are represented as a derivative of the chart depicted within FIG. 2. As shown, each group within a window 40 consists of a plurality of segments representing a specific character. In this example the area covered by each segment is approximately 1/10^{th} of the circumferential arc, or about 36 degrees, thereby representing a character selection area of πr2/10, less the region for the “SP” segment (space character). It should be understood that this approach offers the user a selection area that is notably larger that the traditional graphic QWERTY keyboard representation on portable devices, while occupying the same or preferably a smaller area of the display screen.

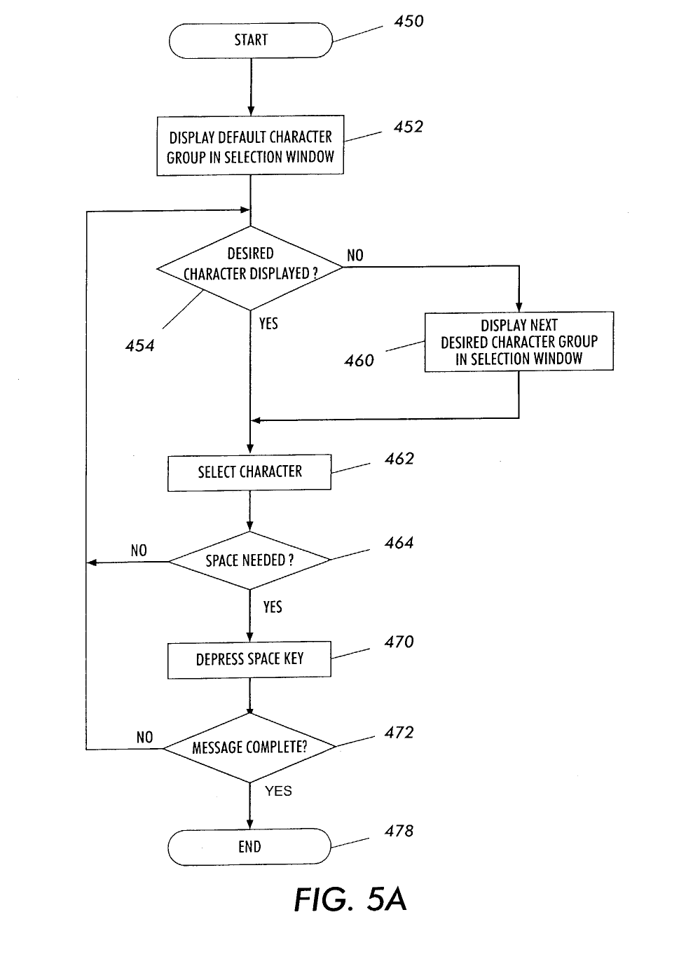

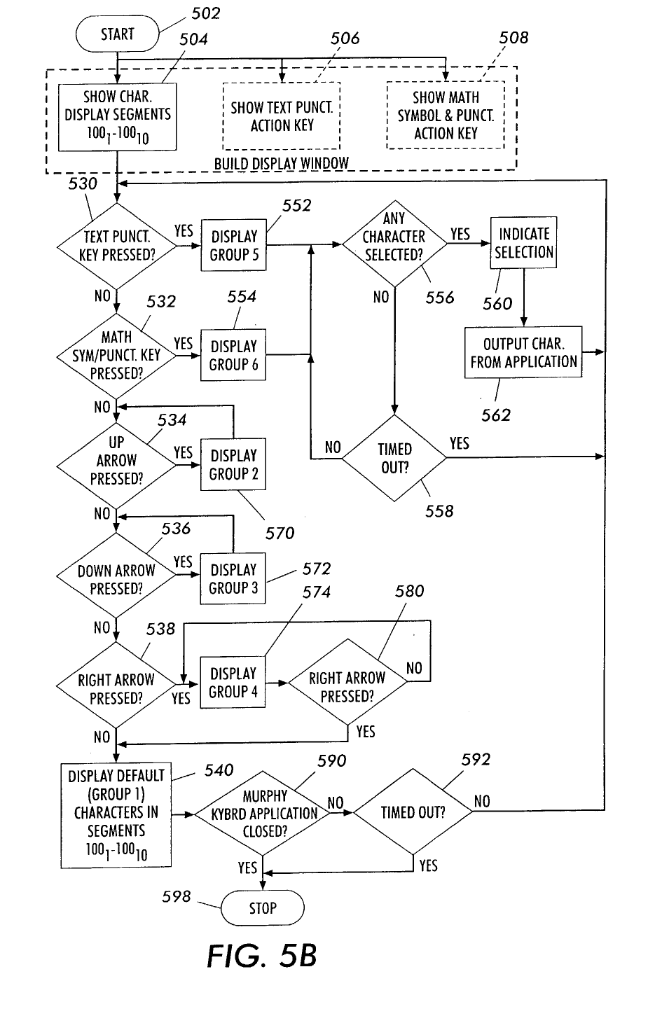

Having described the general operation of the present invention, attention is now turned to FIGS. 5A and 5B, where flowcharts depict the programmatic steps completed by a device in carrying out the character selection process described above. Respectively, the flowcharts depict a character selection process and a keyboard display process. Various methods employed within an embodiment of the present invention are described and taught, for example, in Chapter 13 of “Programming with Microsoft Windows® CE” by Douglas Boling, published by Microsoft Press, 1998, the relevant portions of which are hereby incorporated by reference for their teachings.

Each of these flowcharts run concurrently. In an alternative embodiment, it will be appreciated that the steps set forth in the flowcharts may be combined and/or reordered so as to provide similar functionality. Referring briefly to FIG. 5A, the character selection process is initiated at Step 450, and at Steps 452-460 the default or desired character group is displayed in the selection window in accordance with the process depicted in FIG. 5B. Once the desired character group is displayed, Step 462 continues where a character is selected by the user in accordance with one of a number of well-know selection methods.

Subsequently, a space key selection may be detected and entered at steps 464 and 470. It will be understood that each of the character and/or space selection steps represented herein results in a further output or signaling of such selection to the system or application in which the present application is running, thereby enabling the character selection to be recognized by the application and inserted or added therein.

As depicted at the bottom of FIG. 5A, the character entry process is completed by an affirmative response to step 472, where it terminates in Step 478. Otherwise, the process continues looping at Step 454 to enable the selection and output of additional character and/or space selections by the user in accordance with the process depicted in FIG. 5B.

More specifically, one character display process of FIG. 5B is started at step 502, in response to a user selecting a “Murphy Keyboard” or similar icon (not shown) from the device screen depicting various software applications. Once started, the application program operates to show a character display consisting of a group of character selection segments corresponding to one of the groups set forth in FIG. 2, or other alternatives as discussed herein, as represented at step 504. The alternate action key display functions are also depicted at steps 506 and 508. Although shown as in FIG. 1 as touch-sensitive action keys 60, it is also possible that such functionality is not touch-sensitive but coded in association with a “hard” button 16, in which case the steps of showing the text punctuation and math symbol and punctuation action keys would not be required.

Once the display window is built and displayed at step 510 (including steps 504-508), the keyboard progresses through a sequence of Boolean decision steps (530-538), checking for the selection of any of the action keys. In the event that none are selected, the default display group, Group 1, is displayed in display segments 100₁-100₁₀, as shown in step 540. More specifically, the program builds the representations of the characters for the current group, by default Group 1 from FIG. 2, so as to display the selectable segments in the display window 40. Subsequently, the application enters another decision step, step 590, to determine if the keyboard application has been closed. In the event that it has, progression through the flowchart stops, shown by step 598. If it has not, the final decision making step in the progression, step 592, is entered, which determines if the application has timed out. If the pre-set period of time without activity has expired, stop step 598 is executed. If it has not, the flowchart returns to the head of the decision making sequence, step 530.

The described progression takes place at a fast pace determined only by the speed of the processor performing the steps, continuously checking for the selection of one of the action keys, steps 530-538, closure of the program, step 590, or time out of the program, step 592. In the event that none of these takes place, the effect is that Display Group 1 is continuously displayed in display window 40 by the re-execution of step 540.

Obviously deviations from this routine are possible in the event that the answer to any one of the decision-making steps 530-538 is Yes. As represented by Step 530, one test conducted during this sequence is whether a text punctuation action key has been selected or pressed. In response to detection of a user's selection of the text punctuation action key, the application replaces the characters displayed in segments 100₁-100₁₀ by the characters of Group 5, as represented by step 552. Similarly, in the event that a math symbol action key selection is detected at step 532, the application would replace the characters displayed in segments 100₁-100₁₀ by the characters of Group 6, as represented by step 554.

Subsequent to step 552 or 554, the application would enter a second decision-making step, step 556. In this step, the question is asked whether a character has been selected from the group displayed in the display window. If one has, the selection is entered as input in steps 560 and 562, and action returns to the decision-making sequence step 530. If no selection from the display window was made yet, then decision step 558 is reached, asking whether the timeout period has expired. If it has not, action is looped back to step 556 again. This repeats quickly until either a character is selected from the display window, or until the timeout period elapses. In the event that the timeout period elapses, action returns to step 530 without a character having been selected from the display window. In steps 560 and 562, the selection is indicated by highlighting or otherwise depicting the selection on the character segment of the display. In addition to indicating the selection, the associated character(s) is output from the application—either directly into another application (e.g., a note, meeting entry in a date book, etc.) or to a character data buffer associated with the device for retrieval by another application.

The above case is an example of the access action and the action to depart a character group containing characters that require frequent, but unsustained, access.

Another possible result of the decision-making steps 530-538 is a Yes to either of the decision steps 534 or 536. If there is a Yes from either of these, the result is the replacement of the previously displayed character group with either Group 2 or Group 3 characters, respectively. Once either of these is displayed, the decision-making step that caused it to be displayed is immediately reached again. The result of this is that the selected character group is displayed continuously until the action key corresponding to that character group is released. As many character selections as is desired can be made from this character group while it is displayed, until the action key is released. Upon release, if no other action keys are depressed, the default character group becomes re-displayed as a result of step 540. Here again, various mechanism may be used to detect the selection, including the sensing of a stylus on a touch screen as described above, or the movement of a cursor about the display window and the selection via the depression of a particular selection or “enter” key.

The above case is an example of the access action and the action to depart a character group containing characters that require frequent and sustained access.

A final possible result of the decision-making sequence 530-538 is a Yes to decision-step 538. In this case, the result is the replacement of the previously displayed character group with Group 4 characters. Subsequent to this replacement another decision-making step, step 580, is reached. This step asks whether the action key associated with this character group has been pressed again. If it has not, the Group 4 characters are displayed again. If it has, the group 1 characters are displayed by the action of step 540. The effect of this loop, then, is to display the Group 4 characters continuously until the action key is pressed a second time. Once pressed, Group 1 characters are re-displayed and the flow returns to the decision-making sequence, steps 530-538.

The above case is an example of the access action and the action to depart a character group containing characters that require infrequent, but sustained, access. Although depicted in a simplistic flowchart to represent the basic idea of the process, it will be appreciated that alternative means may be employed for control of the device and in particular the keyboard software application described herein. It will also be appreciated that it may be possible to reprogram, dynamically, certain aspects of the program, including the predefined timer periods, the groups to which characters are assigned, etc.

Another alternative embodiment of the present invention is one where the character display window is separated from the selection keys. Recall that the selection segments and the display window segments are considered separate items, and in FIG. 1 the two items are shown positioned one on top of the other. 22. When the user looks at the display segments, they are actually looking through the selection keys at the display segments. In selecting a character shown in a display segment, they are actually pressing on the selection key that is positioned on top of the display segment.

Two potential benefits of physically separating the selection keys from the display window are to remove the selection keys from the display screen in order to increase available screen space, and to apply the keyboard to devices not having an integrated touch screen, such as some cellular phones, pagers, etc.

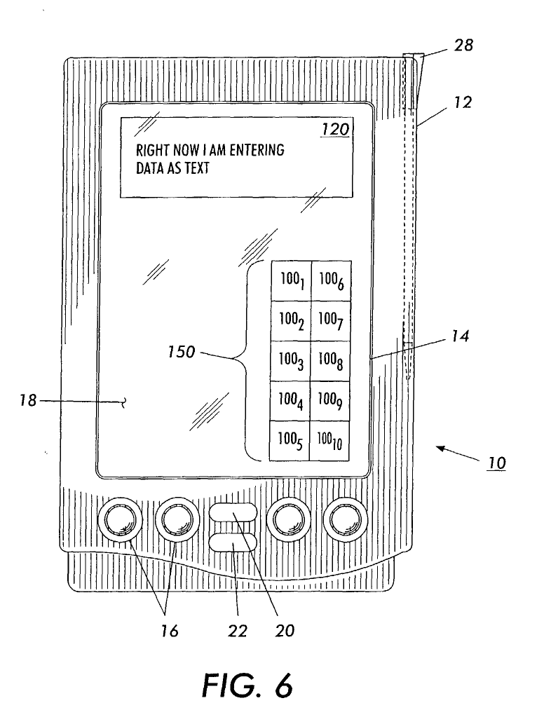

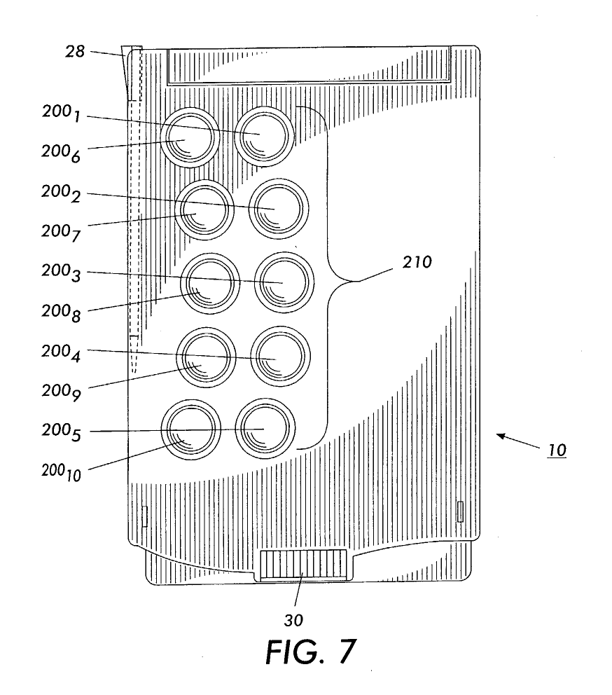

FIGS. 6 and 7 illustrate an alternative character selection and entry embodiment that is independent of a touch screen. In this embodiment, the character display window 150 (FIG. 6) is positioned “above” the selection keys 200 (FIG. 7), with the selection keys being hard keys that sit “under” the display window, on the back of the device. The segments of character display window 150 are positioned to approximately match up with the positions of selection keys 200. In order to select a character, it is up to the user to match up and press the appropriate selection key that corresponds to the display segment containing the desired character. This method is advantageous in that it enables the selection keys to be pressed with fingers, instead of a stylus, and also allows the character display window to be reduced in size from one that has segments that must be large enough for convenient selecting, to one that has segments that only must be large enough to easily view. The manner of switching the character group that is displayed is equivalent to that described earlier.

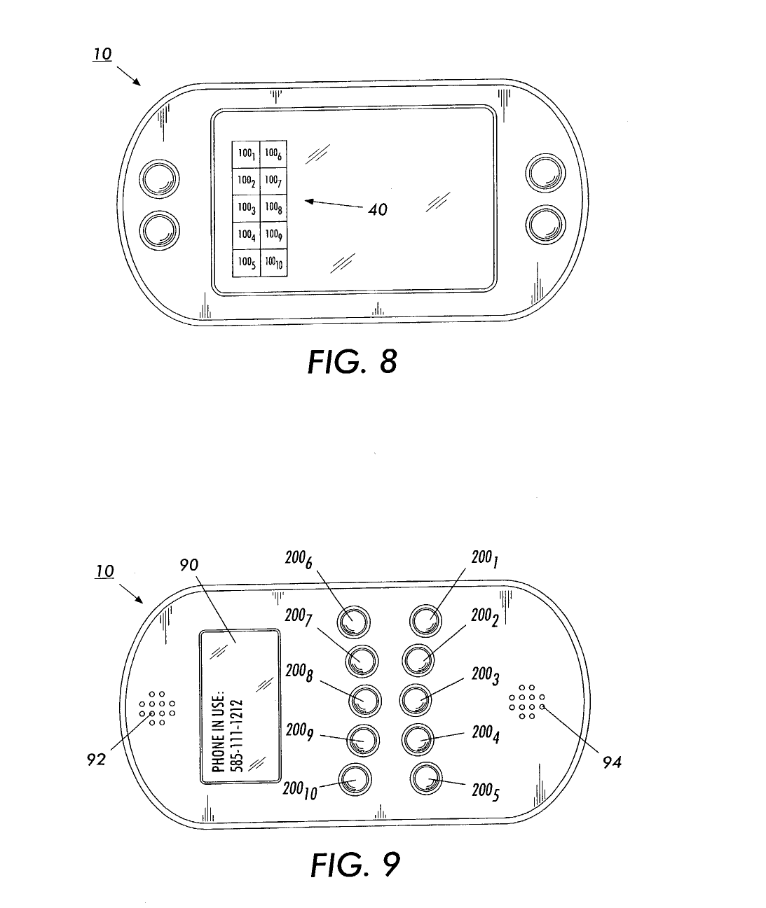

Further utility is provided by this embodiment when a touch screen 15 overlays the display. In this case commands can be entered whereas the one hand 25 is entering commands by way of the touch screen and the other hand is selecting character's physical buttons 200. Keyboard 210 may be a thin film membrane keyboard that can be is affixed to the case of the device 10 and may be electrically connected by means of the user port 30. Alternatively, the keyboard 210 may be integrally manufactured with the device, or at least its outer case, and connected via 30 internal data channels (not shown). FIGS. 8-10 further depict this approach by adapting the display and the button juxtaposition concept to portable personal electronic devices such as cell phones, PDA's, text messagers, VCR and other electronics controllers, and Internet connection devices. In this embodiment the user has available an array of buttons which are ergonomically positioned for one or two-handed operation. Ideally control buttons would be located on the front and character selection buttons on the rear as discussed above. In this manner the user holds the device in both hands and the thumbs activate the top-side buttons and the fingers access the buttons on the underside.

FIG. 8 shows a portable electronic device design that is optimized for fast and convenient input. It uses the character input technique described so far in this application, i.e. a keyboard associated with a display window, that alternately displays a plurality of character groups, and that has selection buttons associated with each position in the display window.

In this optimized device, as with the embodiment in FIGS. 6 and 7, the character selection buttons are placed on the opposite side of the device as the display screen. The same benefits realized above are also realized here: (1) with the selection buttons apart from the display screen, the keys can be made much larger than if they are on the display, (2) with the selection buttons on the back, they can be pressed with fingers, rather than using a stylus, and (3) the character display window size can be minimized. The consequence of this device design is that the display screen can be made as large as the entire front face of the device. This attacks one of the other limitations of portable electronic devices, which is that screen size is generally less than the size needed for easy and convenient viewing, compared with a non-portable device.

With the screen filling one side of the device, and the keys easily fitting on the other, the inevitable compromises that must be made in designing portable devices is changed. Up to now, the fundamental compromise has been between a device design that is small enough to be easily carried, but large enough to fit the display screen plus keypad onto the face of the device. With this aspect of the invention, space for the keypad is no longer a factor because there is plenty of space for the limited number of keys needed, especially when those keys are placed on the opposite side of the device as the display screen. The fundamental design compromise now becomes one of only portability versus screen size, instead of portability versus screen size plus keyboard size.

More specifically, FIG. 8 shows the handheld PC/organizer/Web tool side of the device. The character display window 40 is used just as described earlier, with the display window on the screen and the selection keys on the back (FIG. 9). This layout is designed to maximize display screen space, which is a primary limitation of current handheld PC/organizers. The device is intentionally shaped so that it can be gripped on the short ends in the palm of the user's hands. The two buttons on each end are positioned so that they can be reached with the thumbs. With the device held between the user's palms, the user's four fingers would fall onto the selection buttons on the backside, as shown in FIG. 9. The character display window is shown in the lower left hand corner of FIG. 8.

FIG. 9 shows the selection key side of the device. The selection buttons 200 are available for typing whether using the device from the large screen size, or from the side having the selection keys on it. A small display 90 is also on the selection key side so that conventional cell phone functionality can be included on the device. With display 90, the user can view a telephone number being dialed, exactly as they would use a cell phone today. A speaker 92 and mouthpiece 94 would be included in each end of this device. This device would be held upright, like a cell phone is typically used.

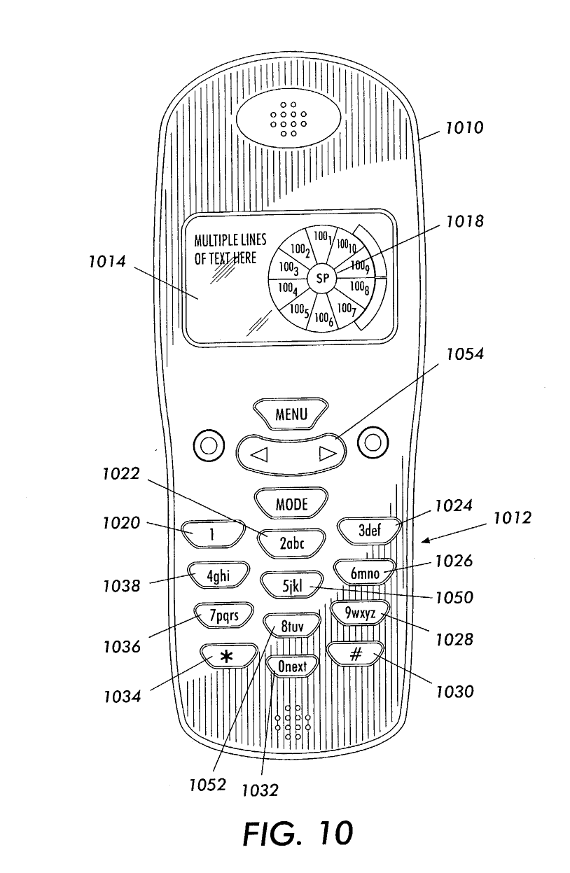

Referring specifically to FIG. 10, there is displayed an alternative embodiment for use in a cellular telephone that does not include a touch sensitive screen. In this embodiment, a cellular phone 1010, such as a Motorola i700 Plus™, is used to enter information for storage in the device (e.g., telephone numbers and names), or for transmission (e.g., text messaging). In one embodiment, 3×4 telephone keypad 1012 may be used to activate the keyboard application as described above. As a result display 1014 is shown with a display window 1018 having a plurality of character segments 100₁-100₁₀ therein. Subsequently, the keypad buttons may be used by a user to select the displayed characters as well as to move through the character groups displayed. The following table represents a proposed keypad button—character segment association, although alternatives are indeed contemplated herein:

| Keypad Button | Ref. Numeral | Char Segment |
|---|---|---|
| 1 | 1020 | 100₁ |
| 2 | 1022 | 100₁₀ |
| 3 | 1024 | 100₉ |
| 6 | 1026 | 100₈ |
| 9 | 1028 | 100₇ |
| # | 1030 | 100₆ |
| 0 | 1032 | 100₅ |
| * | 1034 | 100₄ |
| 7 | 1036 | 100₃ |
| 4 | 1038 | 100₂ |

In order or display alternative character groups, a user would be able to select the remaining keys such as numeric keypad buttons 5 (1050) or 8 (1052), or even left-right rocker button 1054 to “navigate” between the character groups being display in window 1018. Upon selection of the appropriate character group, the user may then select the keypad button associated with a character in order to enter that character.

It will be further appreciated that the application of this user interface organization can be applied to various electronic control applications where the number of commands or execution functions exceeds the number of keys that conveniently fit within the physical dimensions of the device. Applications include (1) various editing and navigational functions or commands in word processing applications, including but not limited to delete, backspace, page-up, page-down, end, home, cut, copy, paste, etc., may be included as one or more special characters such as the space bar, as specific characters in segments, or in other fixed or combined selection buttons or action keys in various aspects of the present invention (2) navigational and command functions in stereo, TV, VCR, or other portable home appliance controllers, including but not limited to volume, channel selection, bass, treble, frequency band, etc (3) navigational and command functions in portable industrial equipment controller applications such as remote PID controllers, electrical and gas meter-readers, or other portable devices for controlling industrial equipment, particularly hand-carried controllers used to communicated with remote field-installed equipment.

As will be appreciated from the various embodiments and methods described herein, the use, methods and operation of the various embodiments of the present invention are directed to a user interface that overcomes the restrictions associated with a limited display area and capitalizes on the intuition of the user to interact with the programmable device to capture text and data. In doing so it is assumed that a limited number of user defined keys or buttons are available to provide navigation between, and within, the character groups. It is further anticipated that the user will readily develop a virtual image of the character groups position to each other. To be more specific, if we were to place the default character group in the center of our mind we would then know that the other two groups of characters are directly above and below, with the symbols group to the right and the punctuation group to the left. In this manner we can assign keys and/or actions to move about in the x and y direction on a cognitively rationalized basis. Additional keys, if available, could be mapped to character selection or assigned to numerous control functions. Furthermore, as described herein, buttons can extend their specific function by adding significance to key action duration and frequency of the actuation and thereby minimize the number of buttons required. In the present invention a hybrid navigation means is presented whereas both the touch screen and the physical buttons are used in the selection of multiplexed character groupings. Additionally areas of the screen are dedicated to execute a global function and emulate the enter key and space bar function of a traditional keyboard.

It should be further appreciated that the present invention may be employed in association with conventional devices that require user input or selection. For example, in addition to the PDA and cellular telephone interfaces depicted in the figures, the one or more aspects of the present invention may be employed for command and similar functions. More specifically, the input methodology set forth above may be used by a user to input control functions or commands, particularly editing commands such as cut, paste, copy, etc. as would be found in conventional PDA and similar hand-held devices. Alternatively, it is further contemplated that the present invention may be employed, for example, in TV, VCR, and/or DVD remote control devices, thereby improving functionality (keeping buttons at a usable size by multiplexing their use. More specifically, the commands might include, but shall not be limited to, rewind, select, volume up, volume down, channel select, etc. This application may further be extended to handheld controllers used in home appliance applications, or handheld controllers used in remote, in-the-field, industrial applications.

In summary, the present invention provides a system for “multiplexing” a given display area to control the displaying of specific character groupings to facilitate user selection and entry or editing of characters into applications. In the first case each character is displayed in a segment of a logically defined grouping of characters within a character array. Character groups are selected by a variety of keys. Each segment can accept the entry or editing of characters therein via a touch screen overlay. The selected character is displayed within a text string for verification purposes. In the second case there is no reliance on a touch screen whereas the user is directed via the display to the required character entry key. The selection and constitution of character groups of a collection of characters can be optimized to maximize speed and accuracy of data entry by a user. The reason that this arrangement is especially advantageous is that it is an exceptionally good compromise between the opposing requirements of short character search times, fast error recovery, and a minimum number of keys.

It is, therefore, apparent that there has been provided, in accordance with the present invention, a method and apparatus for the entry of alphanumeric characters and symbols. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A method of character entry through a user's sequential selection of characters, from a collection of characters, depicted on a display, comprising:
a. dividing the characters of a collection of characters into a plurality of smaller, like-sized groups;
b. providing at least one display window on a display screen;
c. providing an action key for user selection of at least one of the plurality of smaller, like-sized groups of characters;
d. selecting the action key to specify one of the plurality of smaller, like-sized groups of characters for display;
e. displaying at least one of the characters in a specified character group in the display window;
f. providing at least one selection button for at least one of the characters displayed;
g. selecting a character from the characters displayed; and
h. entering the selected character as input:

2. The method of claim 1, wherein the step of dividing the characters of a collection of characters into a plurality of smaller, like-sized groups further includes dividing characters from a plurality of categories of characters.

3. The method of claim 1, wherein the step of dividing the characters of a collection of characters into a plurality of smaller, like-sized groups further includes dividing characters from a single category of characters.

4. The method of claim 1 where the characters are selected from the collection consisting of: alphabetical characters, numerical characters, punctuation marks, symbols, acronyms, commands and user-specified sub-groups of characters.

5. The method of claim 1 wherein the user determines the number of character groups yielded from the collection of characters.

6. The method of claim 1 wherein the user determines the number of characters in a character group.

7. The method of claim 1 wherein the user determines the characters within at least one character group.

8. The method of claim 7 wherein the user further determines the position of a least two characters within at least one character group.

9. The method of claim 1 wherein the criteria for determining which characters are present in a character group is a function of a characters' frequency of use.

10. The method of claim 1 wherein the position of characters within a display window is intentionally determined to take advantage of commonly used sequences of characters.

11. The method of claim 9 where the frequency of character use is monitored and stored, and wherein the step of determining which characters go into a character group is determined as a function of the stored frequency of character use.

12. The method of claim 11 further including the step of continuously monitoring and updating the frequency of character use.

13. The method of claim 1 wherein the size of the display window is adjustable.

14. The method of claim 1 wherein the position of the display window on the display is adjustable.

15. The method of claim 1 wherein the shape of the display window is circular.

16. The method of claim 1 wherein the display window is divided into a plurality of segments.

17. The method of claim 16 wherein there is at least one segment for each character in the displayed character group.

18. The method of claim 1 wherein the step of displaying the characters of at least one of the plurality of character groups comprises simultaneously displaying the characters of a character group in the segments of the display window.

19. The method of claim 16 wherein the number of segments is adjustable.

20. The method of claim 16, wherein the display window is divided into ten segments.

21. The method of claim 16 wherein the boundary of any segment is adjustable.

22. The method of claim 16 wherein the segments are generally pie-shaped.

23. The method of claim 16 wherein the display window contains at least one universal segment that is not associated with the characters of the character groups.

24. The method of claim 23 wherein a character is assigned to the universal segment.

25. The method of claim 23 wherein the universal segment is located at the center of the display window.

26. The method of claim 24 wherein the character assigned to the universal segment is a “space” character.

27. The method of claim 1 wherein the step of specifying the character group, from among the plurality of character groups available for display comprises selecting an action key from a plurality of buttons.

28. The method of claim 27 wherein at least one action key is a key selected from the group consisting of: a hard key; and soft key.

29. The method of claim 27 wherein an action key has more than one character group associated therewith, and the step of specifying the character group, from among the plurality of character groups associated with the action key, desired for display comprises an action selected from the group consisting of:
a single-click;
a double-click;
a user-defined button-click sequence; and
button selection and hold.

30. The method of claim 1 wherein the step of displaying the characters of one of the plurality of character groups in the display window comprises displaying a default character group consisting of a plurality of the most frequently used characters in the collection of characters.

31. The method of claim 27 wherein the step of replacing a displayed character group with the default character group is accomplished by a user action selected from the group consisting of:
a single-click;
a double-click;
a user-defined button-click sequence;
the release of an action key;
automatically by the selection of a character from the displayed character group; and
the expiration of a time-out period.

32. The method of claim 31 wherein the action keys and user actions associated with particular character groups are user-customizable.

33. The method of claim 1 wherein there is at least one selection button for every segment in the display window, and each selection button is associated with only one display window segment.

34. The method of claim 33 wherein the arrangement of the selection keys with respect to one another physically resembles the arrangement of the individual segments in the display window.

35. The method of claim 1 wherein the character displayed in the display window segment at the time that the selection button associated with that segment is selected by a user becomes the character specified for entry.

36. The method of claim 35 wherein the action performed on the selection key determines the case of the character entered.

37. The method of claim 36 wherein a single-click selection action enters a lower-case alphanumeric, and a press-and-hold selection action enters an upper-case alphanumeric

38. The method of claim 36 wherein a double-click of a space character segment is interpreted as the user's selection of a carriage return.

39. The method of claim 1 wherein there is a selection button causing all the characters found in the segments associated with that button to be recorded as input.

40. The method of claim 1 wherein the steps for character entry are controlled by a programmable controller within a hand held electronic device.

41. The method of claim 40 wherein the hand held electronic device includes a touch-sensitive display.

42. A user operable system for the selection of characters utilizing character groups, determined from a collection of characters, depicted on a display screen, comprising:
a. a display window on a display screen;
b. at least one segment within the display window associated with each character in a character group;
c. at least one action key for specifying the character group to display; and
d. at least one character selection key for each display window segment.

43. The user operable system of claim 42 where the physical arrangement of a plurality of selection keys corresponds to the physical arrangement of a plurality of the display window segments.

44. The user operable system of claim 42 where at least one selection key is a transparent soft key.

45. The user operable system of claim 44 where at least one selection key is positioned directly over its associated display window segment.

46. The user operable system of claim 42 where at least one selection key is a hard key.

47. The user operable system of claim 42 where a plurality of selection keys are positioned on the same face of the device as the display window.

48. The user operable system of claim 42 where a plurality of selection keys are positioned on the opposite face of the device as the display window.

49. The user operable system of claim 48 where the physical arrangement of a plurality of the selection keys corresponds to the physical arrangement of a plurality of the display window segments.

50. The user operable system of claim 48 where selection keys are arranged to fit the natural position of a user's fingertips when the device is held.

51. The user operable system of claim 42 further including a speaker and a microphone, and where the selection key is a hard key and is positioned on a surface of the device that does not include the display window.

52. The user operable system of claim 51 where the display screen is of a size such that it fills substantially the entire face of the device.

53. The user operable system of claim 51 where at least one action key is in reach of one of the user's thumbs when the device is held in the palm of the user.

54. The user operable system of claim 51 where the selection keys are arranged in two columns to fit the natural position of the user's finger tips when the device is held in the palms of the user's hands.

55. The user operable system of claim 51 where the microphone and speaker are separated by a distance so as to allow speaking and listening at the same time by the user.

56. The user operable system of claim 51 where there are exactly ten selection keys.

57. The user operable system of claim 51 where the side of the device having the larger display screen is used as a device selected from the group consisting of:
PDA;
personal communication device;
handheld organizer;
text messaging device;
handheld controller; and
a portable Web-surfing tool.

58. The user operable system of claim 51 where the side of the device having the selection keys, microphone, and speaker is used as a communication device.

59. A user operable system for the selection of characters, from a collection of characters, depicted on a display screen, comprising:
at least one character entry group window depicted within the display screen;
selection indicating means, associated with the character entry group window, for indicating a character entry display window wherein each character in said character entry display window is directly associated with a character segment in said selection indicating means;
means for detecting the user selected character within said character group display window; and
means responsive to detecting the user selected character within said character group display window.

60. The system of claim 59, wherein the screen contains a text display window indicating a plurality of the selected characters within the compiled text.

61. The system of claim 60, wherein the text display window facilitates a means for the editing of characters.

62. A user operable character selection and entry system for compiling characters into a text string of characters by selection from a displayed character group comprising:
at least one character group graphic display window within the screen;
a selected character entry means wherein the character group display window is directly associated with a physical character entry key;
means responsive to detecting the user activation of a physical key;
means for detecting the user selection of a character group; and
means responsive to detecting the user selected character group.

63. A user operable system for the multiplexed selection of characters, from a collection of characters, depicted on a display, comprising:
at least one character group depicted in a spatial dimension on a display window of the system;
navigation means for alternately displaying, in a time dimension, one of a plurality of character groups selected from the collection of characters on the display window; and
means for detecting a user selected character within a displayed character group in order to output a signal representing the selected character.
